(19) United States
(12) Patent Application Publication
(10) Pub. No.: US 2007/0011299 A1
(43) Pub. Date: Jan. 11, 2007

(54) System and method for using machine-readable meta-models for interpreting data models in a computing environment

(76) Inventors: Keith I. Farkas, San Carlos, CA (US); Martin F. Arlitt, Calgary (CA); Jerome Rolia, Kanata (CA); Sven Graupner, Mountain View, CA (US); Vijay Machiraju, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/158,376

(22) Filed: Jun. 22, 2005

(51) Int. Cl. G05B 13/02

(52) U.S. Cl. 709/224; 700/29

(57) ABSTRACT

According to one embodiment, a method comprises providing a machine-readable meta-model that defines the structure of how information is represented in at least one data model. The method further comprises using, by a data accessor, the meta-model for interpreting the at least one data model. According to another embodiment, a method comprises providing a machine-readable metric meta-model that defines a syntax for defining metric models, and defining a metric model in the syntax defined by the metric meta-model. The method further comprises associating the metric model with a monitoring source in a monitoring environment, wherein the metric model defines monitoring data available at the monitoring source, and interpreting, by a monitoring tool, the metric model based on the metric meta-model.

### CROSS-REFERENCE TO RELATED APPLICATIONS

This application is related to concurrently filed and commonly assigned U.S. patent application Ser. Nos. [Attorney Docket No. 200404993-1] entitled “SYSTEM AND METHOD FOR AUTONOMOUSLY CONFIGURING A REPORTING NETWORK”; [Attorney Docket No. 200404992-1] entitled “A MODEL-DRIVEN MONITORING ARCHITECTURE”; [Attorney Docket No. 200404994-1] entitled “SYSTEM FOR METRIC INTROSPECTION IN MONITORING SOURCES”; and [Attorney Docket No. 200404995-1] entitled “SYSTEM FOR PROGRAMMATICALLY CONTROLLING MEASUREMENTS IN MONITORING SOURCES”, the disclosures of which is hereby incorporated herein by reference.

### FIELD OF THE INVENTION

The following description relates in general to interpreting data models, and more particularly to systems and methods for providing machine-readable meta-models for use in interpreting data models, such as metric models that specify the metric data available for a monitoring source in a monitoring environment.

### DESCRIPTION OF RELATED ART

Computing systems of various types are widely employed today. Data centers, grid environments, servers, routers, switches, personal computers (PCs), laptop computers, workstations, devices, handhelds, sensors, and various other types of information processing devices are relied upon for performance of tasks. Monitoring systems are also often employed to monitor these computing systems. For instance, monitoring systems may be employed to observe whether a monitored computing system is functioning properly (or at all), the amount of utilization of resources of such monitored computing system (e.g., CPU utilization, memory utilization, I/O utilization, etc.), and/or other aspects of the monitored computing system.

In general, monitoring instrumentation (e.g., software and/or hardware) is often employed at the monitored system to collect information, such as information regarding utilization of its resources, etc. The collected information, which may be referred to as “raw metric data,” may be stored to a data store (e.g., database or other suitable data structure) that is either local to or remote from the monitored computing system, and monitoring tools may then access the stored information. In some instances, tasks may be triggered by the monitoring tools based on the stored information. For example, a monitoring tool may generate utilization charts to display to a user the amount of utilization of resources of a monitored system over a period of time. As another example, alerts may be generated by the monitoring tool to alert a user to a problem with the monitored computing system (e.g., that the computing system is failing to respond). As still another example, the monitoring tool may take action to re-balance workloads among various monitored computing systems (e.g., nodes of a cluster) based on the utilization information observed for each monitored computing system.

Today, monitoring data is collected in the form of metrics that are defined and observed for a monitored computing system. In general, instrumentation and/or monitoring sources are typically configured to collect and/or report various metrics for a given monitored computing system. Various different metric configurations (or “formats”) have been adopted by different monitoring sources. That is, different metric models (or descriptions) have been developed and adopted by different monitoring sources. For instance, different vendors commonly provide monitoring sources that employ different metric models, and in some cases different monitoring source products offered by a common vendor may employ different metric models. As discussed further below, a metric model generally defines the metrics available from a monitoring source. As also discussed further below, models have traditionally been defined in user-readable documents, and have not been implemented in a machine-readable form within a system. Thus, while human users can access the documents specifying a metric model, a computing system itself is not able to read the metric model.

Data models (e.g., metric models) and meta-models are known and used in many areas. In general, a data model is a formal representation of information about data contained in a computing system. One type of data model is a metric model, which provides a formal representation of information about which monitoring data is collected, and where, in a monitoring environment. As an example, the Common Information Model (CIM) is a known standard that defines a metric model (“The CIM Metric Model”). However, the CIM Metric Model defines one (fixed) structure of a metric model assuming that all metrics will be described in this format. This is not realistic in existing monitoring environments where different techniques are used by different vendors. Also, related to the previous point, the CIM Metric Model provides the underpinning of how metric models are defined in the system, but the CIM Metric Model itself is not represented in a machine-readable form in the system. The ways in which information in metric models can be accessed is defined (fixed) and thus built into applications. However, a system does not interpret the syntax of the CIM Metric Model based on a machine-readable description of the metric model, but rather it is up to a human user to have a priori knowledge of the syntax and create his/her monitoring application(s) to comply with such syntax. Additionally, since the CIM Metric Model is fixed, it is also limited in scope and cannot be extended (unless the CIM standard is changed). The CIM Metric Model basically defines a “metric type” having a name, an identifier (“id”), and a related “unit of work” (such as a transaction) to which it is associated.

Other metric models that do not conform to the CIM standard, such as OpenView's metric model, are often used in monitoring sources. OpenView™ (available from Hewlett-Packard Company) introduces a monitoring metric model for measurement data (see “OpenView Measurement Subsystem Meta-Data Model”, November 2003), which is similar to the CIM Metric Model described above, and thus has the same limitations discussed above. Further, other types of data models (other than metric models) are also known to be used in computing systems. For instance, structural models may be used to maintain an abstract yet formal description of the components in the compute environment and their relationships. As with the above-described metric models different vendors and/or different computing systems often employ different data models. Further, such data models have traditionally been defined in user-readable documents, and have not been implemented in a machine-readable form within a system. Thus, while human users can access the documents specifying a data model, a computing system itself is not able to read the data model.

Thus, while various data models (e.g., metric models) have been developed, such models are not provided in a machine-readable format such that a computing system (e.g., monitoring tool) can ascertain the definition of a given model. Rather, a user is traditionally required to understand the model(s) implemented for computing systems, such as monitoring source(s), and hard-code the applications (e.g., monitoring tools) that desire to access the computing system's data in order to comply with the model. For instance, different metric models may be provided (e.g., by different vendors) across different monitoring sources, wherein each metric model follows a different structure (e.g., different configuration or representation of metrics, etc.). Thus, for a monitoring tool to monitor across various monitoring sources that have different metric models, traditionally the monitoring tool must be manually configured for recognizing each metric model. That is, a user must configure the monitoring tool to understand various different metric models, as well as understand which monitoring source utilizes which metric model. This technique is undesirably inefficient and inflexible as it requires a user to reconfigure the monitoring tool for each different type of metric model that the monitoring tool is to encounter (which may change over time if new monitoring sources with which the monitoring tool is to interact are added in the monitoring environment).

### BRIEF DESCRIPTION OF THE DRAWINGS

FIG. 1 shows an exemplary system according to one embodiment of the present invention;

FIG. 2 shows an operational flow diagram according to one embodiment of the present invention;

FIG. 3 shows an exemplary operational flow of the exemplary system of FIG. 1 according to one embodiment of the present invention;

FIG. 4 shows an exemplary monitoring environment that comprises a plurality of data centers, wherein an application migrates from a first data center to another data center;

FIG. 5 shows an exemplary metric meta-model according to one embodiment of the present invention; and

FIG. 6 shows an exemplary metric model that adheres to the exemplary meta-model of FIG. 5.

### DETAILED DESCRIPTION

Embodiments of the present invention employ machine-readable meta-models for interpreting data models in a computing environment. Certain embodiments are employed for use in a monitoring environment by providing machine-readable meta-models that can be used (e.g., by monitoring tools) for interpreting metric models. While many exemplary embodiments are described herein as being employed for interpreting metric models in a monitoring environment, the concepts presented herein are not limited in application for interpreting metric models but may likewise be applied for interpreting any other data models in a similar manner.

In certain exemplary embodiments, a machine-readable meta-model is provided that defines the syntax used for a machine-readable metric model. One or more metric models can be employed within a monitoring environment that follow the defined syntax of the meta-model. A monitoring tool can then access the meta-model to determine the syntax used by the metric models, and can thus understand the syntax of the metric models. By accessing the machine-readable metric model with an understanding of its syntax, the monitoring tool can understand the monitoring data available from the corresponding monitoring source. Thus, the monitoring tool can dynamically adapt to the different metric models employed for different monitoring sources. That is, as discussed further herein, embodiments of the present invention alleviate the need to manually reconfigure monitoring tools to adapt to different metric models that are used across different monitoring sources in a monitoring environment. As discussed further herein, in certain embodiments, a monitoring tool includes a metric parser that is parameterized according to a meta-model, and once parameterized can be used for interpreting (or “parsing”) the corresponding metric model(s) employed by monitoring sources.

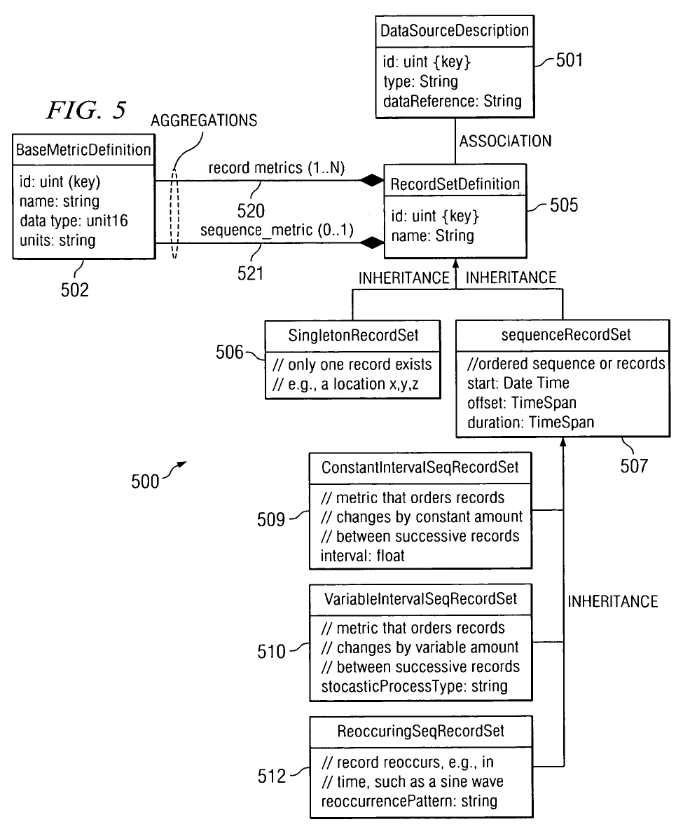

According to one embodiment of the present invention, a machine-readable metric meta-model is provided that defines the structure of how information about monitoring metrics is represented in at least one metric model. That is, the metric meta-model defines the syntax to be used in one or more metric models. In certain embodiments (such as the exemplary embodiment described further below with FIG. 5), in defining the syntax, the meta-model defines the names of the classes that can be used in models, as well as the names of attributes and their types. A monitoring tool can then use the metric meta-model for interpreting the one or more metric models that are employed on monitoring sources.

According to one embodiment, a machine-readable metric meta-model defines a syntax for defining metric models, and a metric model is then defined in the syntax defined by the metric meta-model. The metric model is associated with a monitoring source in a monitoring environment, wherein the metric model defines monitoring data that is available at the monitoring source. A monitoring tool can then interpret the metric model based on the metric meta-model in order to comprehend the monitoring data available at the monitoring source. In certain embodiments, a reference is provided for associating the metric model with its respective machine-readable metric meta-model, whereby the monitoring tool can identify (via the reference) the machine-readable metric meta-model on which the metric model is based and access such meta-model in order to discover the syntax of the metric model.

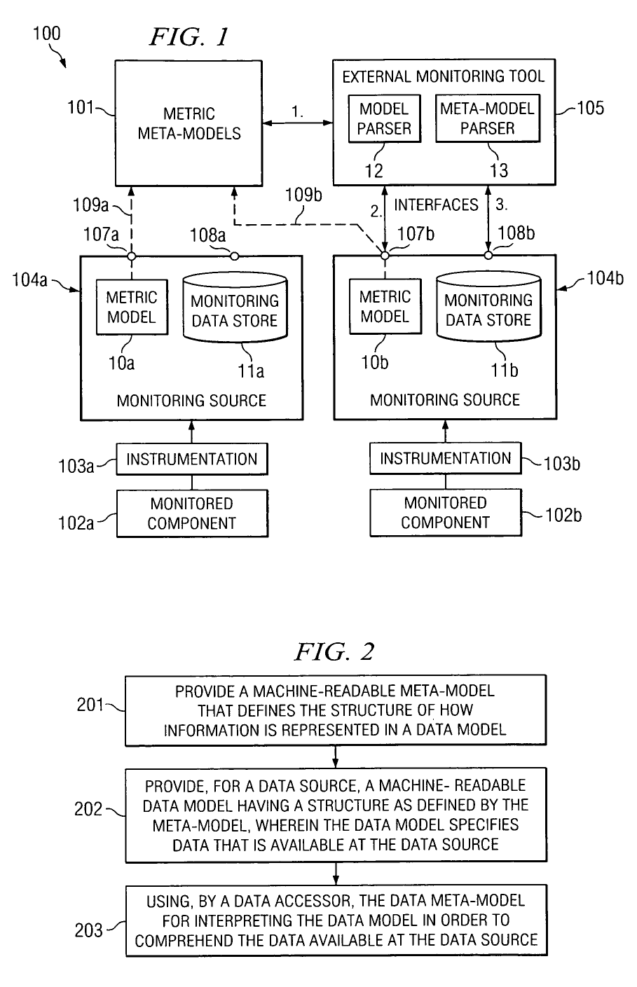

FIG. 1 shows an exemplary system 100 according to one embodiment of the present invention. System 100 includes monitored components 102A and 102B (referred to collectively as monitored components 102) that have respective monitoring instrumentation 103A and 103B (referred to collectively as monitoring instrumentation 103) for collecting monitoring data. For instance, as is well-known in the art, monitoring instrumentation 103 may comprise hardware and/or software for collecting information about monitoring components 102, which may also be referred to herein as “monitored computing systems.” Monitored components 102 may each comprise any type of monitored computing system, such as a data center, grid environment, server, router, switch, personal computer (PC), laptop computer, workstation, devices, handhelds, sensors, or any other information processing device and/or an application executing on such an information processing device. While two monitored components 102 are shown in the exemplary system 100, embodiments of the present invention may be employed for any number of monitored components.

System 100 further includes monitoring sources 104A and 104B. In general, a monitoring source is a component that gathers or stores monitoring data about monitored components, such as monitored components 102A and 102B, in an environment. In the illustrated example, monitoring source 104A stores monitoring data for monitored component 102A, and monitoring source 104B stores monitoring data for monitored component 102B. While two monitoring sources are shown in FIG. 1, any number of such monitoring sources may be employed in a given monitoring environment. Further, while a single monitored component is coupled to each of the monitoring sources in this example, a monitoring source may be implemented for gathering monitoring data for any number of monitored components. Monitoring sources commonly include a monitoring data store for storing monitoring data collected for monitored component(s). For instance, monitoring source 104A includes monitoring data store 11A for storing monitoring data collected for monitored component 102A, and monitoring source 104B includes monitoring data store 11B for storing monitoring data collected for monitored component 102B.

Such data stores 11A and 11B may each comprise any suitable form of computer-readable storage medium, such as memory (e.g., RAM), a hard drive, optical disk, floppy disk, tape drive, etc., and may each store their respective monitoring data in the form of a database or any other suitable data structure. In certain implementations, a given monitoring data store 11 may store monitoring data for a plurality of different monitored components. In certain embodiments, the monitoring data is communicated by monitoring instrumentation 103 to monitoring data stores 11 via a communication network (not shown), such as the Internet or other wide-area network (WAN), a local area network (LAN), a telephony network, a wireless network, or any other communication network that enables two or more information processing devices to communicate data. The monitoring data stored therein may comprise any number of metrics collected for monitored component(s) 102, such as CPU utilization, memory utilization, I/O utilization, etc.

A monitoring tool 105 is further implemented in system 100, which is operable to access (e.g., via a communication network) the collected monitoring data in monitoring data stores 11A and/or 11B. As used herein, a “monitoring tool” refers to any device that is operable to access the collected monitoring data for at least one monitored component. Monitoring tool 105 may comprise a server, PC, laptop, or other suitable information processing device, which may have one or more software applications executing thereon for accessing the monitoring data in monitoring data stores 11A and/or 11B for one or more monitored components, such as monitored components 102A and 102B. Monitoring tool 105 may be implemented, for example, to take responsive actions based on such monitoring data.

In accordance with embodiments of the present invention, metric models 10A and 10B (referred to collectively herein as metric models 10) are implemented for monitoring sources 104A and 104B, respectively, and specify the monitoring data that is available via their respective monitoring sources. As described further herein, metric models 10 define the monitoring data stored at the monitoring sources. Thus, in certain embodiments, the monitoring data stored to monitoring data store 11A is configured in accordance with metric model 10A and the monitoring data stored to monitoring data store 11B is configured in accordance with metric model 10B. Thus, metric models 10 define the structure that the monitoring data at the respective monitoring source follows.

Further, in accordance with embodiments of the present invention, one or more machine-readable metric meta-models 101 are provided, which define the structure (e.g., syntax) used by corresponding metric models 10. Just as a given programming language, such as C, C++, or Java, specifies syntax that may be used for creating any number of programs that a machine can execute (e.g., that a compiler can understand how to interpret into machine-executable code), the meta-model(s) 101 define a framework (or “structure”, e.g., syntax, etc.) which may be followed for creating any number of metric models 10. As described further herein, a monitoring tool 105 can access metric meta-model 101 and thus determine the structure of the corresponding metric model(s) 10. As such, the monitoring tool 105 can dynamically adapt and understand the monitoring data of different monitoring sources which are structured according to different metric models (by accessing the corresponding machine-readable meta-model 101 on which each metric model is based), rather than monitoring tool 105 being required to be manually hard-coded to recognize the structure of each metric model.

Thus, in this illustrative example of FIG. 1, a set of monitoring sources 104 exist in a monitored environment, such as instrumentations or monitoring databases, and each has a metric model 10 associated therewith that defines the structure and kind of monitoring data that is available at the monitoring source. One or more metric-meta models 101 are included which define the structure within which metric models 10 are represented. In this embodiment, each metric model 10 has a reference to the associated metric meta-model 101 defining metric model 10's structure (e.g., its syntax). For instance, the reference to the metric meta-model can be implemented as a hyperlink, or a reference, or a name referring to the corresponding meta-model, as examples. Thus, in certain embodiments, a metric model may include a pointer to its meta-model (via a pre-defined attribute), and a monitoring tool can obtain this information from the metric model provided that the monitoring tool knows the pointer attribute. There may be a pre-defined name (e.g., MetaModelReference) agreed-upon by the monitoring tool developers and the metric model developers that allows the monitoring tool to discover and interpret the pointer contained within a metric model, which would in turn allow the monitoring tool to determine the corresponding meta-model to use for interpreting the remainder of the metric model. Otherwise, each model may have a unique identifier, which, in one embodiment, the monitoring tool uses to query a repository that maintains the mapping between identifiers and meta models.

According to one embodiment, a monitoring source 104 provides an interface 107A and 107B that enables access to the referenced metric meta-model of the monitoring source's metric model 10. Further, a monitoring source 104 provides an interface 108A and 108B that enables access to the monitoring source's monitoring data 11. As indicated by the dotted links shown in FIG. 1, the metric models 10A and 10B each conform to a metric meta-model 101 in this example. Of course, in other embodiments other metric meta-models may be provided and one or more metric models may be provided that conform to the structure defined by one of such meta-models.

A metric model 10 may contain a set of metric descriptions, which include, for example, descriptions of metrics with name, data type, unit, a human-readable definition, and a reference to the associated metric meta-model 101. Further, in some embodiments, metric model 10 includes a set of component descriptions about which monitoring data is collected and to which metrics are associated. An example of such a metric model 10 is shown in table 1 below:

TABLE 1

| | | | Human-Readable | Meta-Model | Component |
|---|---|---|---|---|---|
| Metric Name | Data Type | Unit | Definition | Reference | Description |
| CPU | Integer | Percent | Percentage of the | Meta-Model | Component |
| Utilization | | | component's | A | 102A |
| | | | CPU Utilization. | | |
| Memory | Integer | Percent | Percentage of the | Meta-Model | Component |
| Utilization | | | component's | A | 102A |
| | | | memory | | |
| | | | utilization. | | |
| I/O | Integer | Kbytes/Sec. | Kbytes per | Meta-Model | Component |
| Utilization | | | second utilized | A | 102A |
| | | | by the | | |
| | | | component's I/O. | | |

Table 1 shows an exemplary metric model that specifies that the monitoring source with which such metric model is associated makes available certain metrics, namely CPU Utilization, Memory Utilization, and I/O Utilization in this example. Further, the metric model specifies the data type and unit of each metric available from the monitoring source. In this example, the metric model also includes a human-readable definition of each metric, which enables a user to access (via an interface, such as a GUI) the definitions of each metric to understand those metrics that are available from a given monitoring source. Further, an identification of the component(s) for which each metric is collected is included. Additionally, a reference to the machine-readable meta-model 101 that defines the structure of the metric model is included. While this exemplary metric model references “meta-model A”, another metric model (e.g., associated with another monitoring source) may conform to another structure and thus may reference a different machine-readable meta-model (e.g., a “meta-model B”) that specifies its respective structure (e.g., syntax).

FIG. 2 shows an operational flow diagram according to one embodiment of the present invention. In operational block 201, a machine-readable meta-model is provided that defines the structure of how information is represented in a corresponding data model, such as a metric model. For instance, in one embodiment (such as that of FIG. 1) the machine-readable meta-model 101 defines the structure of how information about monitoring metrics is represented in a metric model (e.g., metric model 10A and/or 10B). That is, the metric meta-model defines the syntax to be used in a metric model. In block 202, a machine-readable data model is provided for a data source (e.g., any computing device/application that makes data available to another computing device/application) having a structure as defined by the meta-model, wherein the data model specifies data that is available at the data source. According to one embodiment, such as that of FIG. 1, a machine-readable metric model (e.g., metric model 10A and/or 10B) is provided for a monitoring source 104 having a structure as defined by the metric meta-model, wherein the metric model specifies monitoring data that is available at the monitoring source. In block 203, a data accessor (any computing device and/or application desiring to access the data available at the data source) uses the meta-model for interpreting the data model in order to comprehend the data available at the data source. In one embodiment, such as that of FIG. 1, a monitoring tool 105 uses the metric meta-model 101 for interpreting the metric model in order to comprehend the monitoring data available at the monitoring source.

Of course, the order of operation in FIG. 2 may differ in certain embodiments. For instance, in certain instances a data model may be defined first, and then a machine-readable meta-model may be provided that defines the structure used in the pre-existing data model. For example, metric models from different vendors may pre-exist, and a corresponding machine-readable metric meta-model may be defined for each metric model. An association between the corresponding metric meta-model and each metric model may exist and be accessible programmatically and thus a monitoring tool can identify (via the reference) the appropriate meta-model that defines the structure of a given metric model. Accordingly, the monitoring tool need not be hard-coded to understand various different metric models that may be employed in a monitoring environment, but rather it can use the meta-model(s) to dynamically understand the corresponding metric models (which may include pre-existing metric models). Thus, such utilization of the metric meta-models eases the integration of various different metric models employed in a monitoring environment for use by a monitoring tool. Thus, while in some instances, a meta-model is first defined and metric models are created in accordance with the structure defined by the meta-model, in other instances a machine-readable meta-model may be created for a pre-existing metric model to define the structure (e.g., syntax) used in such pre-existing metric model.

Returning now to FIG. 1, in one embodiment, access by monitoring tool 105 to metric data (or “monitoring data” 11) of a monitoring source 104 is a two-stage process. In a first stage, the metric meta-model 101 is interpreted in order to parse and interpret the metric model 10 of the monitoring source to be accessed. Thus, the monitoring tool 105 uses a model parser 12 that can be instrumented by a meta-model 101 in order to validate associated metric models 10, as described further herein. In the second stage, the monitoring data is extracted from the chosen metric model 10 of the monitoring source of interest. In the exemplary system 100 of FIG. 1, monitoring tool 105 also includes meta-model parser 13, which is operable to determine the input to the model parser 12, as described further herein.

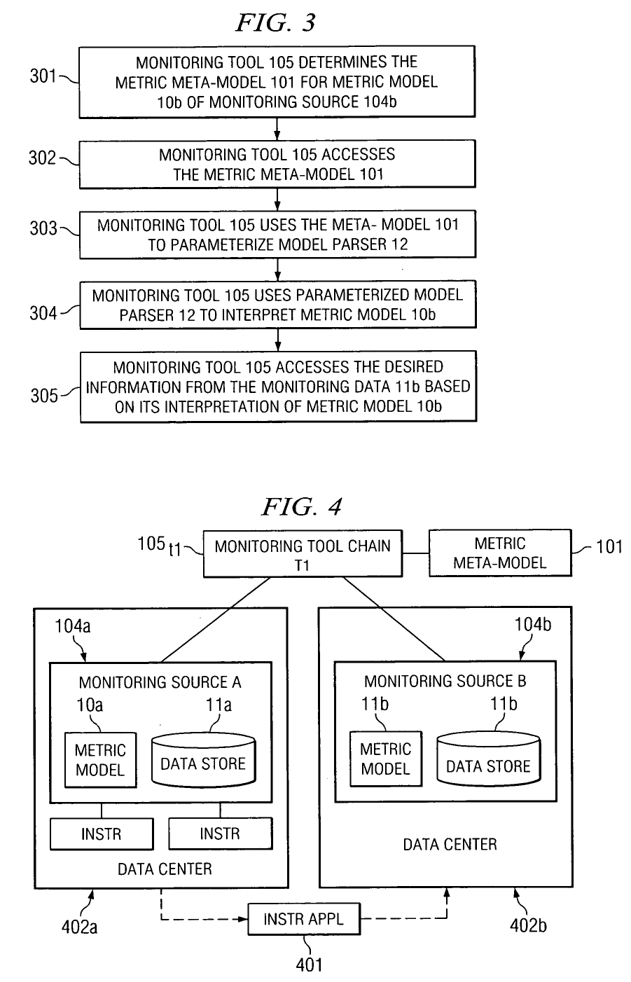

As an example of operation of one embodiment of the present invention, suppose that monitoring tool 105 desires to access monitoring data 11B of monitoring source 104B. FIG. 1 shows exemplary operations (numbered 1-3 in FIG. 1) that may occur when monitoring tool 105 desires to access monitoring data 11B of monitoring source 104B according to one embodiment of the present invention, which are described further below in connection with the corresponding exemplary operational flow of FIG. 3. That is, FIG. 3 shows an exemplary operational flow of the exemplary system 100 of FIG. 1 according to one embodiment of the present invention.

In operational block 301, monitoring tool 105 determines the metric meta-model 101 for metric model 10B of monitoring source 104B. That is, monitoring tool 105 determines that metric meta-model 101 defines the structure (e.g., syntax) used in metric model 10B. In certain embodiments, monitoring tool 105 determines such meta-model 101 by accessing metric model 10B and determining its corresponding meta-model 101 via metric model 10B's reference to such meta-model 101. In operational block 302 (process 1 of FIG. 1), monitoring tool 105 accesses the metric meta-model 101. According to one embodiment, meta-model parser 13 reads the textual representation of the meta-model (e.g., in the form of an XML file) and creates an internal data structure (referred to as a “parse tree”) according to which the metric model is then interpreted by the model parser 12. The model parser 13 accesses and uses the parse tree in order to parse and interpret models. The metric meta-model 101 is used, in block 303, to parameterize the internal model parser 12 in the monitoring tool 105, and such parameterized model parser 12 is then used, in block 304 (process 2 of FIG. 1), to interpret the metric model 10B that is obtained from the monitoring source 104B. Interpretation of the metric model 10B then allows access to the actual monitoring data 11B, in block 305 (process 3 in FIG. 1). That is, monitoring tool 105 accesses the desired information (e.g., the desired metrics) from the monitoring data 11B based on its interpretation of metric model 10B. Once monitoring tool 105 understands the metric model 10B, it can determine how to access/interpret the monitoring data 11B available from monitoring source 104B.

Embodiments of the present invention allow better integration of monitoring systems provided by different vendors (using different structures of data and configuration information). That is, embodiments of the present invention allows the integration of different metric models (e.g., as may be provided by different vendors), wherein each metric model can use a different structure of the data, such as a different format, syntax, representation, etc. Thus, for instance, metric models provided by different parties using different structures of the monitoring data can be integrated within a monitoring environment by introducing a meta-model as part of the system, which automatically guides the interpretation of metric models (by monitoring tools) without the need for reconfiguration of the monitoring tools.

Exemplary meta-models and metric models that may be formed in accordance with certain embodiments of the present invention are described further below. In general, a meta-model defines the structure of how information about a subject (monitoring metrics in this case) is represented in a computing system. Traditionally, meta-models are commonly defined and described outside the computing system, such as in form of human-readable specification documents. Those documents are commonly referred to by developers or integrators for building compatible solutions. Thus, knowledge about the meta-model is traditionally built into solutions and is hard to change afterwards. Embodiments of the present invention extend the concept of a meta-model from being a document read and understood by human beings for guiding the construction of solutions, by making the meta-model part of the system itself. That is, the meta-model is represented in machine-readable form in the system, and is referred to for interpreting corresponding metric models. In this manner, meta-models and corresponding metric models may, in certain embodiments, be used in a manner similar to that employed for XML (extensible markup language) documents and XML Schema documents. XML documents are validated against XML Schema documents, which are represented in the system as XML documents themselves and referred to by the XML parser when interpreting XML documents.

According to one embodiment, a metric meta-model 101 is generic and provides the format and syntax for the definition, storing and access of descriptive data about metrics (called metric models, such as metric models 10A and 10B). Metric models 10 are associated with monitoring sources (such as instrumentations or monitoring databases) 104 in a monitoring environment, and describe the kind of monitoring data made available at a monitoring source 104. As described above, in certain embodiments, each metric model 10 follows a syntax that is defined by a meta-model 101 to which it keeps a reference. The meta-model 101 itself is formally defined and represented in machine-readable form in the system, thus allowing systems and components (e.g., monitoring tool 105) to read and interpret the metric meta-model 101 first in order to interpret a metric model 10 in order to understand how to extract desired information about specific metrics that are available at a monitoring source 104.

Machine-representation of the metric models and metric meta-models allows for automated discovery and interpretation of monitoring metrics, which in turn allows for automating the configuration and reconfiguration of monitoring tools (e.g., to enable monitoring tool chains processing, storing, and/or reporting monitoring data when changes occur in a monitoring environment).

Thus, a machine-readable metric model enables automated, model-driven configuration and reconfiguration processes in tool chains accessing, processing and reporting monitoring information. Model-driven reconfiguration means that tools are capable of interpreting meta-data about the system, such as metrics describing monitoring data that are available in a monitoring environment, and reconfiguring themselves automatically when the meta-data indicates that a change has occurred in the environment. As an example of a change in a monitoring environment, suppose that a monitoring environment comprises a plurality of data centers and an application may migrate from one data center into another, as shown in FIG. 4. That is, FIG. 4 shows an exemplary monitoring environment that comprises data centers 402A and 402B that are monitored by monitoring tool chain 105ₜₗ, wherein an application 401 migrates from data center 402A to data center 402B. As a result of this migration from data center 402A to data center 402B, monitoring source 104B begins collecting monitoring data for the migrated application 401 and thus serves as the new source of monitoring data for application 401. A tool chain 105ₜₗ may become aware of this change from an information service that maintains information about the physical and logical systems in the monitored environment and the relationships between them. Such information service maintains relationships, meta data, and models about the monitoring sources, the data consumers, and the reporting network, all of which are used to provide monitoring data to the data consumers. An exemplary information service that may be used in certain embodiments is described further in co-pending and commonly assigned U.S. patent application Ser. No. [Attorney Docket No. 200404992-1 titled “A MODEL-DRIVEN MONITORING ARCHITECTURE,” the disclosure of which is hereby incorporated herein by reference. From information discovered via the information service, tool chain 105ₜₗ, may determine that it needs to read the meta-model corresponding to the model of the monitoring source that collects monitoring data for the monitored component that now hosts the migrated application. That is, the tool chain 105ₜₗ may reconfigure itself for adapting to the change, in the example, to access monitoring data for the migrated application 401 from the new monitoring source 104B collecting monitoring data in the new data center 402B.

FIG. 5 shows an exemplary metric meta-model 500 which can be understood by understanding the underlying structure of the meta-model. The definition of the underlying structure can be implicitly given and built into the monitoring tool accessing information in the metric meta-model, or can be explicitly defined and represented in the system (e.g., in machine-readable form). This exemplary metric meta-model 500 described three components of a metric model: the definitions of the metrics in the model, how the metrics can be grouped into sets of measurement records (i.e., records), and the data source for these record sets. The template for the metric definitions used by corresponding metric models is provided by BaseMetricDefinition 502. It describes the attributes that a metric model may define. These attributes include a unique identifier (id), a name, a data type, and the units. The template for the record set used by such a metric model is provided in metric meta-model 500 by RecordSetDefinition 505. RecordSetDefinition 505 describes the attributes that an instance of a record definition may define. These include a unique identifier, and a name describing the record. Each record set comprises one or more metrics. Metric meta-model 500 uses the aggregation 520 (record metrics) to define the template that is used by metric models to capture the one or more metrics that comprise a record. Finally, the template for the data source of a given RecordSetDefinition 505 instance is provided by DataSourceDescription 501. As before, it describes the attributes that may be defined by the data source of a data set including a unique identifier, and information for accessing the actual records.

Metric meta-model 500 subclasses the RecordSetDefinition 505 into five subclasses 506, 507, 508, 510 and 512. SingletonRecordSet 506 defines the template used by metric models that adhere to metric meta-model 500 to describe a record set that comprises a single measurement, such as the location of an object that is considered to be fixed. Similarly, sequenceRecordSet 507 defines the template used by metric models to describe ordered sequences of records. The records in a record set sequence are ordered by the value of a given metric. Metric meta-model 500 uses the aggregation 521 to define the template that is used by metric models to capture the basis for a sequence. The metric meta-model 500 provides a template for describing record set sequences in which each record in the ordered sequence has a value of the ordering metric that is a constant amount greater than the previous record. This template is ConstantIntervalSeqRecordSet 509. Similarly, VariableIntervalSeqRecordSet 510 defines the template for sequence definitions in which the records are separated by a non-constant (i.e., a variable) amount. Finally, ReoccuringSeqRecordSet 512 provides the template for describing a sequence that repeats.

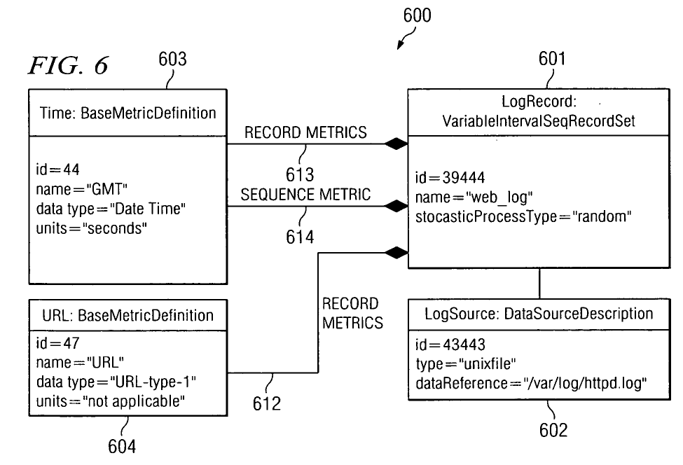

FIG. 6 provides an exemplary metric model 600 that adheres to the metric meta-model 500. Metric model 600 is one exemplary metric model that may be implemented for a given monitoring source, such as metric model 10A of monitoring source 104A in FIG. 1. This metric model 600 defines a web log, such as one that is maintained by a web server to record the web pages that it servers to clients. A web log comprises a number of records, with each record comprising the URL of a web page that was accessed and the time at which it was accessed. Further, the records are ordered by time, and, since these web page accesses do not occur at deterministic intervals of time, the record sequence is said to be a variable interval sequence.

These properties of the web log are described in the model 600 by the log record LogRecord 601, the metric definitions Time 603 and URL 604, and the log source 602. LogRecord 601 is an instance of the meta-model 500 template VariableIntervalSeqRecordSet 510 (See FIG. 5). Metric model 600 assigns values to the attributes described in the template VariableIntervalSeqRecordSet 510, specifically, a unique log record set id (39444), a name (“web_log”), and a description of the process that defines the interval between records (“random”). Metric definitions Time 603 and URL 604 are instances of the meta-model 500 template BaseMetricDefinition 502, and capture the details of these two metrics through the assignment of values to the attributes defined by BaseMetricDefinition 502. Aggregation record metrics 612 and 613 describe the metrics that comprise the LogRecord 601 record set, while the sequence metric 614 aggregation describes the Time 603 metric as the time base for the record set. Finally, LogSource 602 describes the log source for the record set, and, as before, assigns values to the attributes defined by metric meta-model 500 DataSourceDescription template 501.

The attributes and structure of the meta-model 500 are understood by monitoring tool developers and are encoded in the tools themselves. A monitoring tool can then use this information to decode metric models such as metric model 600. In one embodiment, this decoding is done by meta-model parser 13 (FIG. 1), which constructs a parser using the information contained in meta-model 500. Then, model parser 12 (FIG. 1) uses the parser defined by the meta-model parser to parse a given metric model, for example, model 600, extracting the information it encodes. For example, in the case of model 600, the model parser may indicate that the metric model describes a variable interval record set sequence names “web log”, whose values are available from a unix file. In one embodiment, a single meta-model can be used to describe multiple metric models, and as such, a single monitoring tool can autonomously understand these multiple metric models. In another embodiment, a monitoring tool encodes knowledge about the multiple meta-models that may be in use so that it has the context for interpreting them. In yet another embodiment, the developers of the meta-models and the monitoring tool developers can define a meta-model, which describes the syntax, etc., of the meta-models. Such a meta-model that describes the syntax used in the meta-models (that in turn describe the syntax of data models, such as metric models) may be referred to as “meta-meta-models.” In this embodiment, the monitoring tool developers will encode in the tool an understanding of how to interpret the meta-meta-model. This understanding will allow the tool to autonomously interpret any meta-model that adheres to the meta-meta-model.

An exemplary machine-representation of the meta-model 500 of FIG. 5 is as follows. The language used is based on the known language Management Object format (mof) see http://www.dmtf.org/education/mof/):

class BasicMetricDefinition
{

[key] uint32 id;
String name;
String data type;
String units;

};
class RecordSetDefinition
{

[key] uint32 id;
String name;
DataSourceDescription REF dataSource;
BaseMetricDefinition REF sequenceMetric;
BaseMetrieDefinition REF recordMetrics[]

};
class DataSourceDescription
{

[key] uint32 id;
String type;
String system;
String dataReference;
String accessInformation;

};
class singletonRecordSet : RecordSetDefinition( );
class sequenceRecordSet : RecordSetDefinition
{

DateTime start;
sint32 offset;
sint32 duration;

};
class ConstantIntervalSeqRecordSet : sequenceRecordSet
{

float interval;

};
class VariableIntervalSeqRecordSet: sequencedRecordSet
{

String stocsticProcessType;

};
class ReoccuringSeqRecordSet : sequenceRecordSet
{

String reoccurencePattern:

};

Of course, the exemplary meta-model of FIG. 6 may be implemented using other forms of machine-readable representations, and is thus not limited to the above exemplary representation.

Consider now the following example, which illustrates the use of a metric meta-model and a metric model to support adaptation in a monitoring environment to changes occurring in the system in accordance with one embodiment of the present invention. In this example, two monitoring domains that use different formats of models (e.g., one monitoring system using HP OpenView, and another monitoring system using IBM Tivoli models) are implemented in a monitoring environment. This exemplary use case is typical in practice when monitoring environments span multiple organizational and management domains, such as multiple data centers, departments or even corporations. An example of such an environment includes supply-chain applications where IT (information technology) systems of different vendors are connected. Another, more recent development, are so-called Virtual Organizations (VOs) introduced by the Grid that may also span multiple management domains in multiple locations and data centers. Different management solutions can be applied in those domains using different model formats (in addition to many other differences). An embodiment of the present invention may be employed to provide integration at the model-level between different management systems enabling model-driven monitoring and management in those environments.

In this exemplary use case, there are two metric meta-models assumed for the two management domains (one for OpenView and one for Tivoli). Each management system uses its own model format (syntax) of metric models in each environment. Now assume that a monitoring consumer (e.g., monitoring tool 105 of FIG. 1) wishes to extract metrics in an environment with different applications managed with different management systems (such as OpenView and Tivoli). In accordance with one embodiment, the monitoring consumer first obtains the metric model from the first environment. The meta-model is used to direct the model parser used in the monitoring consumer to read and interpret models. Reading the metric meta-model enables the monitoring consumer to parse (“understand”) all metric models that conform to that meta-model (e.g. all metric models in the same monitoring domain). Then, the monitoring consumer may obtain one or more metric models from monitoring sources and parses them using the meta-model instrumentation. After parsing, the monitoring consumer is able to traverse the parsed information in order to obtain the desired metric information from the model.

This process is repeated for metric models in the second monitoring domain by instrumenting the model parser with the meta-model for the second domain. This now enables the monitoring consumer to parse (“understand”) models in the format used in the second domain.

If/when the environment changes (e.g. new metrics become available, or older metrics disappear), the monitoring consumer repeats the process of obtaining metric meta-models and using them for parsing metric models from different environments in order to obtain updated metric information. Co-pending U.S. patent Ser. No. [Attorney Docket No. 200404992-1] describes an exemplary information service that may be used in certain embodiments for enabling the consumer to become aware of changes in the monitored environment.

While meta-model information 101 is shown as stored centrally (or externally) to monitoring sources 104 in the example of FIG. 1, in certain embodiments the meta-model information may be attached directly to metric models 10 (e.g., stored locally within monitoring sources 104), which would allow the immediate deployment of monitoring instrumentation in a new environment without having to install a new metric meta-model first. In certain embodiments, a meta-model repository may be implemented, which stores one or more meta-models for metric models implemented within a monitoring environment.

While various exemplary embodiments have been described above as being employed for interpreting metric models in a monitoring environment, the concepts presented herein are not limited in application for interpreting metric models but may likewise be applied for interpreting any other data models in a similar manner.

For instance, in certain exemplary embodiments, a machine-readable meta-model is provided that defines the syntax used for a machine-readable structural model. One or more structural models can be employed within a computing environment that follow the defined syntax of the meta-model. These structural models retain information about the components in the environment, how they are composed together, and the properties of these compositions. In a given computing environment, there may be multiple models in use each with different syntax. A management tool, such as one that allocates systems to applications, can then access the meta-model to determine the syntax used by the various structural models, and can thus understand the syntax of the various structural models. By accessing the machine-readable structural model with an understanding of its syntax, the management tool can understand the composition and organization of the corresponding computing environment. Thus, the management tool can dynamically adapt to the different structural models employed in the same computing environment, or in multiple computing environments.

What is claimed is:

1. A method comprising:
providing a machine-readable meta-model that defines the structure of how information is represented in at least one data model; and
using, by a data accessor, the meta-model for interpreting said at least one data model.

2. The method of claim 1 wherein said at least one data model comprises at least one metric model, and wherein said machine-readable meta-model defines the structure of how information about monitoring metrics is represented in said at least one metric model.

3. The method of claim 2 wherein said using comprises:
using, by a monitoring tool, the meta-model for interpreting said at least one metric model.

4. The method of claim 3 wherein said at least one metric model is machine-readable.

5. The method of claim 3 wherein said at least one metric model defines the monitoring metrics that are available via a corresponding monitoring source.

6. The method of claim 3 wherein said using comprises:
said monitoring tool parameterizing a model parser according to the meta-model.

7. The method of claim 6 further comprising:
said monitoring tool using said model parser to interpret monitoring metrics available from a monitoring source.

8. The method of claim 1 wherein said at least one model is machine-readable.

9. The method of claim 8 wherein said at least one model defines data that is available via a corresponding data source.

10. The method of claim 1 wherein said using comprises:
said data accessor parameterizing a model parser according to the meta-model.

11. A method comprising:
providing a machine-readable metric meta-model that defines a syntax for defining metric models;
defining a metric model in said syntax defined by said metric meta-model;
associating said metric model with a monitoring source in a monitoring environment, wherein said metric model defines monitoring data available at the monitoring source; and
interpreting, by a monitoring tool, the metric model based on the metric meta-model.

12. The method of claim 11 wherein said defining said metric model comprises:
providing a machine-readable representation of said metric model.

13. The method of claim 11 further comprising:
linking said metric model to said metric meta-model that defines the syntax used for said metric model; and
said monitoring tool discovering said metric meta-model via said linking.

14. The method of claim 11 wherein said interpreting comprises:
said monitoring tool parameterizing a model parser according to the metric meta-model.

15. The method of claim 14 further comprising:
said monitoring tool using said model parser to interpret monitoring metrics available from said monitoring source with which said metric model is associated.

16. A method comprising:
providing a machine-readable metric meta-model that defines a syntax for defining metric models;
defining a metric model in said syntax defined by said metric meta-model;
associating said metric model with a monitoring source in a monitoring environment, wherein said metric model defines monitoring data available at the monitoring source;
associating said metric model with said machine-readable metric meta-model; and
interpreting, by a monitoring tool, the metric model based on the metric meta-model.

17. The method of claim 16 wherein said interpreting comprises:
identifying, by the monitoring tool, the machine-readable metric meta-model.

18. A system comprising:
a data source storing data;
a data model that defines data that is available via said data source; and
a machine-readable meta-model that defines the structure of how information is represented in the data model.

19. The system of claim 18 further comprising:
a data accessor operable to use the meta-model for interpreting said data model.

20. The system of claim 18 wherein said at least one data model comprises at least one metric model, and wherein said machine-readable meta-model defines the structure of how information about monitoring metrics is represented in said at least one metric model.

21. The system of claim 20 wherein said data source comprises a monitoring source.

22. The method of claim 21 wherein said metric model defines the monitoring metrics that are available via said monitoring source.

23. The system of claim 18 wherein said metric model is machine-readable.

24. A system comprising:
a machine-readable metric meta-model that defines a syntax for defining metric models;
a metric model in said syntax defined by said metric meta-model, wherein said metric model is associated with a monitoring source in a monitoring environment and wherein said metric model defines monitoring data available at the monitoring source; and
a monitoring tool operable to interpret the metric model based on the metric meta-model.
